(19) United States
(12) Patent Application Publication
(10) Pub. No.: US 2015/0137416 A1
(43) Pub. Date: May 21, 2015

(54) Advanced Thermal Processing Techniques of "Sacrificial" Polylactic Acid

(71) Applicant: The Board of Trustees of the University of Illinois, Urbana, IL (US)

(72) Inventors: Jason F. Patrick, Urbana, IL (US); Scott R. White, Champaign, IL (US); Nancy R. Sottos, Champaign, IL (US); Jeffrey S. Moore, Savoy, IL (US); Brett P. Krull, Savoy, IL (US)

(73) Assignee: The Board of Trustees of the University of Illinois, Urbana, IL (US)

(21) Appl. No.: 14/540,324

(22) Filed: Nov. 13, 2014

Related U.S. Application Data
(60) Provisional application No. 61/904,094, filed on Nov. 14, 2013.

(51) Int. Cl. D01F 1/10; B29C 47/00; D01F 6/62

(52) U.S. Cl. CPC D01F 1/10; D01F 6/62; B29C 47/0014; B29C 47/0004; B29C 47/0064; B29K 2067/046
USPC 264/211

(57) ABSTRACT

A method of making a sacrificial fiber, comprising: forming a molten sacrificial composition comprising a poly(hydroxyalkanoate) and a metal catalyst; extruding the molten sacrificial composition to form a sacrificial fiber comprising the poly(hydroxyalkanoate) and the metal catalyst, where the concentration of the metal catalyst in the sacrificial fiber is at least 0.1 wt %.

### REFERENCE TO RELATED APPLICATIONS

This application claims the benefit of U.S. Provisional Application No. 61/904,094 entitled “Advanced thermal processing techniques of “sacrificial” polylactic acid (PLA) for fabrication of microvascular networks and inverse architectures in polymers and fiber-reinforced composites” filed Nov. 14, 2013, which is incorporated by reference in its entirety.

### BACKGROUND

Composite materials possess desirably high strength/stiffness-to-weight ratios; however, synthetic composites typically lack the dynamic functionality that occurs in natural composite materials. Natural composites, for example, rely on pervasive vascular networks to enable a variety of biological functions in both soft and hard tissue. Load-bearing composite structures such as bone and wood are lightweight and have high strength/stiffness, but also contain extensive vasculature capable of transporting mass and energy.

An ongoing challenge in materials science is the development of microvascular networks in synthetic composites, where the composite materials may be formed using conventional composite manufacturing processes. Specialized fabrication methods such as laser micromachining, soft lithography, templating with degradable sugar fibers, and incorporating hollow glass fibers or polymeric tubes can produce some microvascular structures in composite materials. These specialized methods, however, are not currently suitable for rapid, large-scale production of fiber-reinforced composites with complex vasculatures.

A requisite for creating more damage tolerant microvascular networks, e.g. those mimetic of hierarchical vasculature in natural systems [1], is the ability to fabricate branched and interconnected “sacrificial” precursors. An incessant microvascular manufacturing challenge has been to recreate complex, biomimetic architectures with sacrificial, vascular precursors that can also survive structural host material integration requirements. Prior developed direct-write assembly [2, 3] of wax-based fugitive inks produces intricate, 3D interconnected vascular templates that can be incorporated into solid polymer systems via liquid monomer infusion [4-8]. These sacrificial scaffolds however, are too delicate to survive fiber-reinforced composites (FRC) processing under elevated temperatures and/or compaction pressure. The vaporization of sacrificial components (VaSC) process [9, 10], with metal catalyst infused thermoplastic PLA, has proven to be an efficient method for creating microvascular networks throughout a FRC. Three-dimensional, interpenetrating vasculature to improve in situ mixing of liquid healing agents has been constructed in FRC laminates [11] via interwoven sacrificial PLA fibers. However, the resulting microchannels lack spatial interconnectivity and thus limit fluidic pathway redundancy.

Pending U.S. patent application Ser. No. 13/416,002 to Esser-Kahn et al., published as U.S. Patent Application Publication No. 2013/0065042, outlines the invention of “sacrificial” poly(lactic acid) (PLA) fibers via embedment of low concentrations of metal oxide catalyst. Such fibers can be integrated, e.g. woven, into structural fiber-reinforced composites (FRC) and later vaporized by heat treatment to form pervasive microfluidic conduits. The method of US 2013/0065042 is characterized by the ability to tune the PLA depolymerization temperature to about 200° C., so as to fall in a narrow window above the about 180° C. typical of FRC composite processing conditions, but below typical FRC epoxy matrix degradation temperatures of about 200-240° C.

US 2013/0065042 teaches incorporating tin (II) oxalate (SnOx) solid catalyst particles by swelling the commercially available PLA fibers in a solution of SnOx in a solvent, whereby the SnOx locally ingresses into the fiber periphery and a portion even remains on the fiber surface. While the procedure is effective in creating microvascular conduits in FRC, the evacuations can be inconsistent and in some cases incomplete due to blockages from residual SnOx particle agglomerations within the micro-channels.

### SUMMARY

Provided herein is a method of making a sacrificial fiber. The method comprises forming a molten sacrificial composition comprising a poly(hydroxyalkanoate) and a metal catalyst, and extruding the molten sacrificial composition to form a sacrificial fiber comprising the poly(hydroxyalkanoate) and the metal catalyst. The concentration of the metal catalyst in the sacrificial fiber is at least 0.1 wt %.

Also provided is a method of forming a polymeric degradable structure. The method comprises supplying a sacrificial filament to an extrusion nozzle, extruding the sacrificial filament from the extrusion nozzle, and cooling the sacrificial filament. The sacrificial filament comprises a poly(hydroxyalkanoate) and a metal catalyst, where the concentration of the metal catalyst in the sacrificial filament is at least 0.1 wt %.

In addition, an improved method of forming a polymeric degradable structure is provided. The method comprises feeding a sacrificial filament to a fused deposition modeling (FDM) device, extruding the sacrificial filament, and depositing the sacrificial filament to form the degradable structure. The improvement comprises feeding to the FDM device a sacrificial filament comprising a poly(hydroxyalkanoate) and a metal catalyst, where the concentration of the metal catalyst in the sacrificial filament is at least 0.1 wt %.

To provide a clear and more consistent understanding of the specification and claims of this application, the following definitions are provided.

The term “polymeric” means a substance that includes a polymer.

The term “polymer” means a substance containing more than 100 repeat units. The term “polymer” includes soluble and/or fusible molecules having long chains of repeat units, and also includes insoluble and infusible networks.

Unless otherwise specified, polymer molecular weights (Mw) are defined in terms of weight average molecular weights.

The term “matrix” means a continuous phase in a material.

The term “catalyst” means a substance that accelerates a process.

The term “sacrificial” means a composition that can be intentionally removed.

The term “degradable structure” means a structure manufactured with a sacrificial material.

The term “sacrificial polymer” means a sacrificial composition including a catalyst in a polymer matrix.

The term “molten sacrificial composition” means a sacrificial composition including a catalyst in a molten polymer matrix.

The term “melt-spinning” means extruding a molten composition, such as a molten sacrificial composition, through a spinneret or die, to form a fiber or filament.

The term “microfluidic channel” means a substantially tubular structure having a diameter less than 1,000 micrometers.

The term “microfluidic network” means a plurality of channels having a plurality of interconnects, where at least a portion the channels have a dimension less than 1,000 micrometers.

The term “network precursor” means a composition that will form a hollow, interconnected network of “microfluidic channels” when it is removed.

The term “fluid communication” means that two objects are in an orientation, and within a sufficient proximity to each other, such that fluid can flow from one object to the other. The term “fluid” means a substance in the liquid or gaseous state. In one example, if a microfluidic channel embedded in a matrix is in fluid communication with a surface of the matrix, then fluid can flow from the channel onto the surface.

The term “fiber” means a cylindrical shaped element whose length is at least 10 times larger than its average diameter.

The term “filament” means a fiber having an average diameter equal to or more than 1 mm.

The term “spinneret” means a circular opening through which melted material is passed to form a “fiber” upon cooling and solidification.

The term “die” means a circular opening through which melted material is passed to form a “filament” upon cooling and solidification.

Unless otherwise specified, concentrations of a catalyst in a sacrificial polymer are expressed in terms of “wt %”, which designates proportions of catalyst as percentages of the weight of the polymer(s) in the sacrificial polymer.

### BRIEF DESCRIPTION OF THE FIGURES

The invention can be better understood with reference to the following drawings and description. The components in the figures are not necessarily to scale and are not intended to accurately represent molecules or their interactions, emphasis instead being placed upon illustrating the principles of the invention. Moreover, in the figures, like referenced numerals designate corresponding parts throughout the different views.

FIG. 1 depicts X-ray computed microtomographies (μCT) of a number of PLA fiber types revealing distribution of denser (white) SnOx catalyst particles.

FIG. 2 illustrates isothermal thermogravimetric analyses (TGA) of a number of SnOx/PLA polymer samples at 200° C. over 16 hours. “%” values designate proportion of SnOx by weight of PLA.

FIG. 3 illustrates used deposition modeling (FDM) of a sacrificial polymer including PLA. FIG. 3A: Optical image of 3D printed microvascular network precursor with branching; FIG. 3B: Scanning electron micrograph (SEM) of evacuated network at T-junction (thickness in vertical direction) with “hourglass” geometry resulting from dual-layer construction.

FIG. 4 illustrates stages of a branched microvascular composite fabrication: FIG. 4A: Layered, 2D woven (E-glass) reinforcement with stitched (through-thickness) sacrificial PLA fibers in a parallel configuration, physically constraining planar branched network precursors; FIG. 4B: Chemically bonded through-thickness fibers to branched precursors via manual solvent-welding (PLA/SnOx/DCM:1/20/100 by wt.); FIG. 4C: Optical image of pre-VaSC fiber-reinforced composite; FIG. 4D: μCT reconstruction showing section of three-dimensional, interconnected microvasculature (scale bars: a-c=10 mm, d=5 mm).

FIG. 5A illustrates an example thermal extrusion apparatus for the melt-spinning of sacrificial fibers (dashed box indicates location of magnetic sensor/computer addition in (5B); FIG. 5B illustrates increased precision in winding reel speed control via bicycle computer assembly; FIG. 5C illustrates a rotational speed calibration curve for converting km/h output from bicycle computer to RPM (scale factor=5.5).

FIG. 6 illustrates tensile stress versus strain behavior for a number of PLA-based fibers. Plain “commercial” fiber is tested as received for reference, whereas all other fibers are melt-compounded, melt-spun and contain 3 wt % SnOx. Dashed lines represent elastic modulus (E) calculated up to 1% engineering strain (s).

FIG. 7 illustrates an example melt-extrusion assembly for preparation of sacrificial (SnOx/PLA) filament feedstock having a diameter of about 3 mm diameter for fused deposition modeling (FDM).

FIG. 8 illustrates an isothermal thermogravimetric analysis characterizing the degradation process of neat PLA, commercially spun PLA fibers solvent-infused with SnOx, melt-spun PLA with 5 wt % SnOx, and melt-spun PLA with 5 wt % SnOc.

FIG. 9 illustrates representative stress-strain profiles from tension testing of sacrificial PLA. FIG. 9A: before thermal treatment. FIG. 9B: after thermal treatment (175° C., 20 minutes). Note the reduction in failure strength of PLA with tin (II) octoate (SnOc) catalyst incorporated.

### DETAILED DESCRIPTION

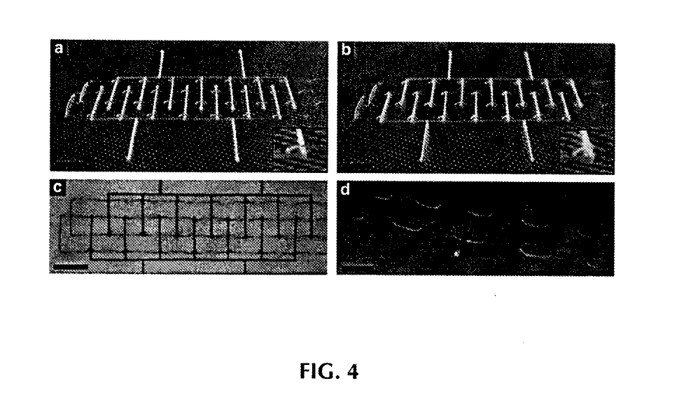

Disclosed herein are advancements in material processing methods that result in an increased versatility of sacrificial poly(hydroxyalkanoates). This is achieved through thermal processing of fibers for automated or hand-weaving and of filaments for fused deposition modeling (FDM) of branched interconnects. Chemical and mechanical tuning achieves targeted vascularization of product fiber-reinforced composites (FRC) in seamless integration with conventional manufacturing techniques, processing survival, and consistent in situ evacuation from the product composites. The resulting newfound capabilities in microvascular architecture are demonstrated through fabrication of state-of-the-art FRC prototypes, as exemplified in FIG. 4.

In one aspect, a method is provided for producing thermally degradable sacrificial fibers and filaments by melt-spinning a sacrificial polymer including a polyhydroxyalkanoate and a metal catalyst. A poly(hydroxyalkanoate) is an aliphatic polyester having the general structure:

O—C(R¹R²)—(CR³R⁴)ₓ—C(═O)ₙ

where n is an integer of at least 10, x is an integer from 0 to 4, and R¹-R⁴ independently are —H or an alkyl group. Examples of poly(hydroxyalkanoate)s include poly(3-hydroxybutyrate) (P3HB), poly(4-hydroxybutyrate) (P4HB), poly(3-hydroxyvalerate) (PHV), polycaprolactone, poly(lactic acid) (PLA), poly(glycolic acid) (PGA), and copolymers of the monomeric units of these polymers. They weight average molecular weight of the poly(hydroxyalkanoate) is preferably at least 50 kDa to at most 500 kDa, and more preferably at least 200 kD to at most 400 kDa.

Example metals include alkaline earth metals or transition metals dispersed in a poly(hydroxyalkanoate) matrix. In representative embodiments, the metal is preferably present in the planar material as a metal oxide, such as MgO, CaO, BaO, or SrO. The metal may also be present as a metal triflate, such as scandium triflate (Sc(OTf)₃). More preferably, the metal is present as an organic metal salt, such as a metal oxalate, metal acetate, or metal octoate. Particularly preferred are metal oxalates, such as tin (II) oxalate (SnOx).

In representative embodiments, the weight fraction of the catalyst in the sacrificial polymer is at least 0.1 wt %, at least 0.5 wt %, at least 1 wt %, at least 2 wt %, at least 2.5 wt %, at least 3 wt %, at least 5 wt %, at least 7 wt %, or at least 10 wt %. In representative embodiments, the weight fraction of the metal in the planar material may be from 0.1 to 10 wt %, from 1 to 7 wt %, from 2 to 5 wt %, or from 2.5 to 3.5 wt %. Preferably, the catalyst is sieved and/or ground to particles of an average diameter of less than 1/10^{th} of the minimum dimensions of the desired feature of the product to be obtained with fibers or filaments of the sacrificial polymer.

Poly(lactic acid) (PLA) is a thermoplastic poly(hydroxyalkanoate) that degrades by depolymerizing at temperatures above 280° C., forming lactide as a gaseous degradant. Existing epoxy processing protocols, however, can require milder processing conditions, to prevent damage to the epoxy matrix. Although the making of a thermally degradable fiber by melt-spinning had been disclosed in US 2013/0065042, it was not known which catalysts and catalyst amounts incorporated into PLA fibers and filaments could best provide a material that would survive required polymer-processing conditions but still depolymerize within an appropriate temperature range, without degrading the desirable mechanical properties of the fibers and filaments below the degradation temperature. US 2013/0065042 also disclosed manufacturing sacrificial fibers by solvent spinning, a technique also known as “liquid spinning”. Melt-spinning is advantageous over solvent/liquid spinning, as there is typically a shorter wait time for the product fiber to cool and solidify after melt-spinning as opposed to the required time for complete evaporation of solvent following solvent spinning. Additionally, inhomogeneous solvent evaporation may lead to irregular, e.g. flat or tape-like, fiber cross-sections.

By adopting SnOx as the metal catalyst in the sacrificial polymer, the PLA depolymerization temperature of the melt-spun fibers and filaments can be tuned to about 200° C., so that it exists in a narrow window above the about 180° C. typical of FRC composite processing conditions, but below typical FRC epoxy matrix degradation temperatures of about 200-240° C. The product melt-spun fibers and filaments are characterized by a more homogeneous metal catalyst dispersion than in the case of the solvent-infused fibers of US 2013/0065042, and exhibit faster evacuations with drastically reduced propensity for blockages.

In representative embodiments of this first aspect, raw pellets of commercial PLA of a desired average molecular weight, and particles of a catalyst, are combined via solvent-blending or melt-blending to create a sacrificial polymer. The reactivity of the catalyst is preferably not so high as to induce degradation of the PLA at typical melt processing temperatures and times, as this may result in excessive degradation of the sacrificial polymer before the time of intended removal. Different amounts of catalyst may be used in order to tune the velocity of PLA degradation, where higher catalyst concentrations usually lead to shorter degradation times. Tin-based catalysts, such as SnOx, are preferred.

Solvent-blending may be achieved by dissolving a poly(hydroxyalkanoate) in a solvent, for example an organic solvent such as dichloromethane (DCM) or chloroform, followed by the addition of a desired amount of a catalyst, to form a dispersion. Then, the dispersion is poured into a flat vessel and left to dry until the solvent has evaporated, leaving a sacrificial polymer. Melt-blending relies upon melting the poly(hydroxyalkanoate) polymer above the melting temperature such that a liquid mixture is attained for distributing the catalyst throughout.

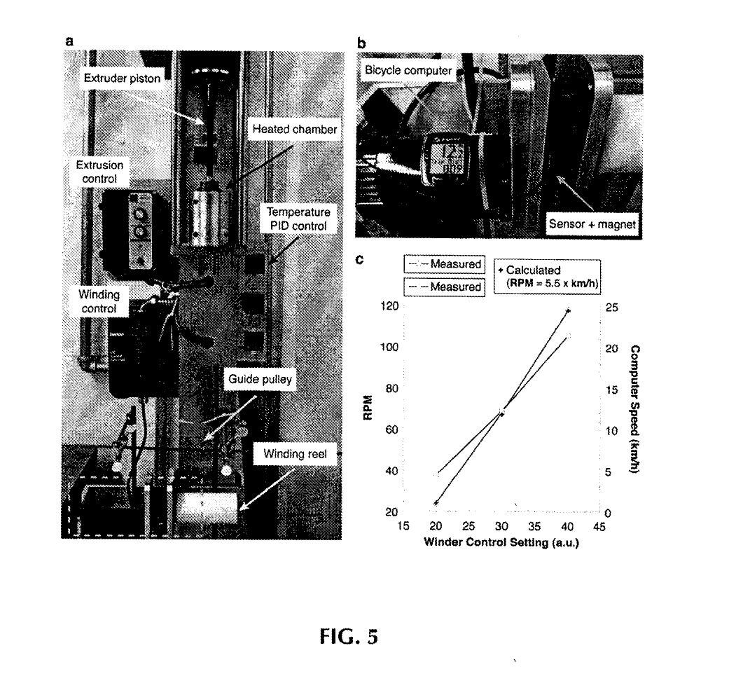

The sacrificial polymer is heated to form a molten sacrificial composition that is melt-spun into a fiber, for example with a melt-spinning extrusion apparatus such as that shown in FIG. 5A. Post-spinning, the mechanical properties of the product fibers may be improved upon by subjecting the fibers to heated drawing at a temperature above the glass-transition temperature and below the melting temperature of the sacrificial polymer. Larger diameter filaments may be obtained by, for instance, by extruding a sacrificial polymer through a die having an internal diameter larger than that used for the melt-spinning of fibers.

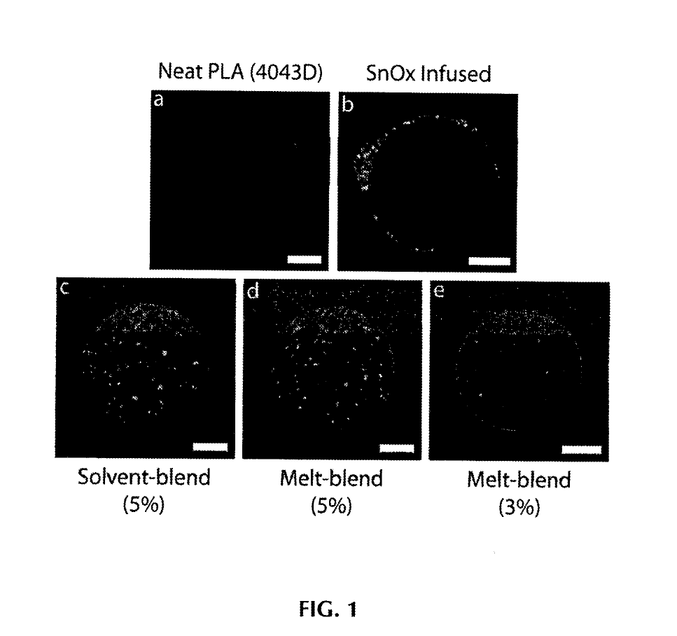

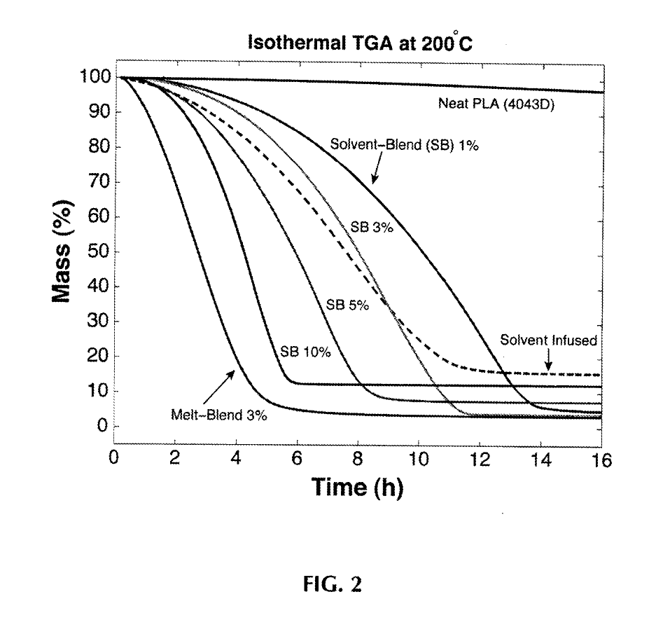

FIG. 1 illustrates an example dispersion of sieved tin (II) oxalate (SnOx) solid catalyst particles within poly(lactic) acid (PLA) polymer from solvent- and melt-blending techniques compared to the prior solvent-infusion method of US 2013/0065042. X-ray computed microtomography (μCT) of various PLA fiber types revealing distribution of denser (white) SnOx catalyst particles: (a) Neat PLA (4043D, Natureworks) fiber; (b) SnOx solvent-infused commercial PLA monofilament (Nextrusion) showing surface agglomeration of catalyst; (c) Solvent-blended, melt-spun fiber with sieved (U.S. Std. No. 500) SnOx catalyst at 5% by weight of the PLA; (d) Melt-blended and melt-spun fiber with sieved SnOx catalyst at 5% by weight PLA; (e) Industrially melt-blended, in-house melt-spun fiber with ground SnOx catalyst particles (of diameter less than 25 μm) at 3% by weight PLA (scale bars=100 μm). FIG. 2 illustrates through isothermal thermogravimetric analysis (iTGA) the enhanced thermal degradation of new solvent or melt-blended SnOx/PLA compared to sacrificial material produced by the solvent-infusion method of US 2013/0065042.

The method of melt-spinning of this first aspect provides a scalable manufacturing process to produce continuous lengths of sacrificial fibers over a range of diameters (on the order of micrometers). Table 1 reports example fiber dimensions produced with laboratory-scale equipment:

TABLE 1
Typical sacrificial, melt-spun fiber size
and quantity produced per 30 g batch.

| Wind Rate (RPM) | Fiber Diameter (μm) | Total Length (m) |
|---|---|---|
| 25 | 850 ± 20^{†} | 36 |
| 33 | 750 ± 20 | 48 |
| 41 | 650 ± 20 | 60 |

^{†}Error represents standard deviation from measurements taken every 5 meters along the length.

Heated-drawing of the fibers served to improve mechanical properties (Table 2) such that sacrificial fibers produced by spinning were robust enough to be incorporated into composite textile reinforcement by hand and automated-weaving processes:

TABLE 2
Summary of average mechanical properties
from single-fiber tensile tests.

| | | | | Elastic |
|---|---|---|---|---|
| Fiber | Diameter | Yield Stress | Yield Strain | Modulus* |
| Type | (μm) | (MPa) | (%) | (GPa) |
| Undrawn | 740 ± 40^{†} | 48.7 ± 1.6 | 2.9 ± 0.1 | 2.1 ± 0.2 |
| 2:1 Draw | 455 ± 25 | 61.5 ± 4.7 | 2.5 ± 0.4 | 3.2 ± 0.3 |
| 3:1 Draw | 385 ± 15 | 89.4 ± 4.7 | 2.8 ± 0.1 | 4.1 ± 0.1 |
| 4:1 Draw | 320 ± 5 | 135.0 ± 2.3 | 3.0 ± 0.0 | 5.7 ± 0.1 |
| Commercial | 200 ± 1 | 102.1 ± 1.8 | 1.8 ± 0.1 | 6.8 ± 0.2 |

^{*}Elastic modulus calculated up to 1% strain;
^{†}Error represents standard deviation from at least three samples.

Sacrificial filaments characterized by larger average diameters (e.g. 1.75, 3 mm nominal) can also be produced, for example by fitting a melt-spinning apparatus with a heated die extension having a sufficiently large internal diameter. Such sacrificial filaments can be used as feedstock for fused-deposition modeling (FDM) machines. For instance, a filament from a spool can be fed to a 3D printer, and branched vascular precursors can be robotically deposited. The printed template constructions can then be integrated between composite reinforcing layers (plies) and connected to interwoven sacrificial fibers, for example by solvent-welding techniques. The resulting post-vascularization produces 3D-interconnected microvasculature throughout a FRC laminate. As such, the sacrificial filaments provide a capability to produce a virtually limitless number of multi-dimensional sacrificial template constructions.

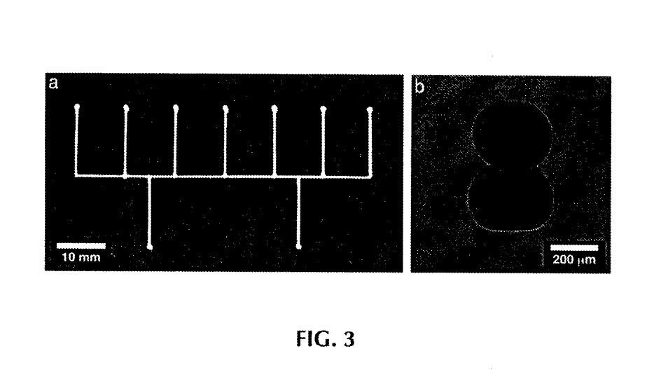

FIG. 3 illustrates the specific example of a branched sacrificial template and resulting inverse vasculature formed after thermal depolymerization within an epoxy matrix. FIG. 4 demonstrates the specific example of a branched sacrificial template attached to melt-spun fibers and the resulting 3D interconnected, inverse vasculature formed within a fiber-reinforced polymer composite.

The following examples are provided to illustrate one or more preferred embodiments of the invention. Numerous variations can be made to the following examples that lie within the scope of the invention.

### EXAMPLES

### General Materials and Procedures

PLA pellets having a weight average polymer molecular weight of 150 kDa were obtained from Natureworks (Ingeo 4043D). Commercially spun PLA fibers 300 μm in diameter were obtained from Nextrusion, Germany. Catalysts tin (II) oxalate (SnOx) and tin (II) octoate (SnOc) were obtained from Sigma-Aldrich, St. Louis, Mo. Dichloromethane (DCM) was used as received from Sigma-Aldrich. Epoxy resin (Araldite LY 8605) and amine hardener (Aradur 8605) were used as received from Huntsman Advanced Materials, The Woodlands, Tex. Epoxy/composite samples were prepared using a mass ratio of 35 parts per hundred (pph) Aradur to Araldite LY 8605.

Isothermal thermogravimetric analysis (iTGA) experiments were performed on a Mettler-Toledo (Columbus, Ohio) TGA851e, calibrated with indium, aluminum, and zinc standards. For each experiment, the sample of about 8 mg was accurately weighed (with a precision of about 0.02 mg) into an alumina crucible. The mass loss was recorded concurrently with a heating ramp cycle from 25° C. to 200° C. at 20° C./min, and then held constant at 200° C. for 16 hours, all under continuous nitrogen purge.

Differential scanning calorimetry (DSC) was performed on a TA Instruments Q20 module calibrated with indium and zinc standards. Dynamic experiments were conducted in hermetically sealed Tzero aluminum crucibles under a nitrogen atmosphere to measure heat flow (positive exotherm) throughout a temperature sweep from 0 to 300° C. at a heating rate of 10° C./min. The glass transition temperature of the matrix material (Araldite/Aradur 8605) was measured according to ASTM E1356 provisions [12] and reported as the inflection (midpoint) of the endotherm.

Single PLA fibers were loaded in direct tension according to ASTM D3822 [13] provisions using a TA Instruments' RSA3 mechanical analyzer. The fiber gauge length was set to 25 mm by adhesively-bonded, paper loading tabs that were held aligned in the fixture by bolt-tightened grips. The quasi-static tests were performed in displacement-controlled mode at a rate of 300 μm/min until complete failure (e.g. fracture) or an engineering strain level of approximately 18% was reached.

Visualization of the denser SnOx catalyst particles within PLA polymer fiber was accomplished via X-ray computed microtomographic (μCT) imaging on an Xradia (Pleasanton, Calif.) MicroXCT-400. 182° scans are obtained in rotation intervals of 0.25° using a 20× objective (1 μm/pixel resolution) at 5 s exposure times with 40 kV (200μA, 8 W) source settings. Cross-sectional images were obtained via Xradia TXM Controller (v. 8.1.7546).

Composite sample fabrication was achieved by a vacuum assisted resin transfer molding (VARTM) procedure. The layup sequence for VARTM processing from bottom to top was as follows:

BOTTOM (B). Machine finish aluminum plate (400 mm×400 mm-width×length) covered with adhesive backed release tape (350 mm×350 mm).

B1. Greenflow 75 (Airtech International, Huntington Beach, Calif.) high performance, low-profile resin distribution medium (250 mm×280 mm).

B2. Porous nylon release peel ply (280 mm×250 mm) (Fibre Glast Developments, Brookville, Ohio).

B3. Four layers (250 mm×230 mm) of [90/0] 8-harness satin weave E-glass (0.31 kg/m2) (Style 7781, Fibre Glast Developments).

MIDDLE. Fiber textile preform containing sacrificial templates (250 mm×230 mm).

T3. Four layers (250 mm×230 mm) of [90/0] 8-harness satin weave E-glass (0.31 kg/m2) (Style 7781, Fibre Glast Developments).

T2. Porous nylon release peel ply (280 mm×250 mm) (Fibre Glast Development).

T1. Greenflow 75 (Airtech International) high performance, low-profile resin distribution medium (250 mm×280 mm).

TOP (T). Stretchlon® 800 (Airtech International, Inc.) high-temp. vacuum bagging film.

Prior to infusion, epoxy resin and amine hardener were combined (60 g resin: 21 g hardener) in five separate containers, mixed thoroughly, and degassed at room temperature (RT) under 12 Torr vacuum (abs) for 45 min. (Yamato ADP31 drying oven, Welch 1402 vacuum pump). The individual mixtures were then combined into one container by carefully pouring along the container sidewall to prevent additional air entrainment, and the total collection was degassed under the same temperature/vacuum conditions for one additional hour.

VARTM was ultimately accomplished by applying 38 Torr (abs) vacuum (Welch DryFast® Tuneable Chemical-Duty Vacuum Pump: model 2032B-01) until complete fabric wetting and then decreased to Torr (abs) for 36 hours at room temperature (RT) until resin solidification. The fiber-reinforced composite panel was post-cured for 2 hours at 121° C. plus 3 h at 177° C. (Thermo Scientific Lindberg/Blue M) resulting in a final glass-transition temperature of about 150° C. as measured by DSC.

Vaporization of sacrificial components (VaSC) from post-cured neat epoxy and fiber-composite host materials began with cutting samples using a diamond-blade wet saw to expose sacrificial fiber cross-sections and then wet-sanding (240 grit) until smooth. Air-dried samples were then placed in an evacuation oven (Jeio Tech OV-11, Korea) at RT and heated to 200° C. for 24 h under 12 Torr (abs) vacuum. The evacuated, microvascular composites were removed once the oven had cooled back to RT. The vasculature was then flushed with water to verify evacuation followed by compressed air.

μCT images of evacuated networks were acquired on an Xradia MicroXCT-400 after filling the empty microvasculature with liquid Iohexyl/Omnipaque 350 serving as a radiocontrast agent. In order to prevent over attenuation when branches of the planar networks become longitudinally aligned with X-rays, the composite was mounted in the sample holder with a 15° tilt from the primary stitch direction. 204° scans are obtained in rotation intervals of 0.25° using a 0.5× objective (40 μm per pixel resolution) at 1 s exposure times with 60 kV (133 μA, 8 W) source settings. 3D image reconstructions are performed using Xradia TXM Reconstructor software (v. 8.1.7546). Images were produced via Xradia TXM 3D Viewer and Amira (v. 5.5.0).

Scanning electron micrographs (SEM) were acquired on a Phillips XL30 ESEM-FEG at 2 kV, after sputter-coating the samples with gold/palladium for 60 seconds using a Denton Desk II TSC-turbo pumped unit. National Institute of Health's (NIH) Image J software was employed for calibrated, digital measurements.

### Example 1

### Solvent-Blending SnOx-PLA

Solvent blending was achieved by combining 20 g of PLA (4043D [14], Natureworks, molecular weight approx. 150 kDa [15]) in a glass container with 200 mL of dichloromethane (DCM) and sealed until the PLA was fully dissolved, which typically took 24 hours with intermittent manual agitation. The desired proportion of SnOx/SnOc (per wt. % of the PLA) was then added to the solution and shaken until uniformly dispersed. Immediately after agitation, the viscous mixture was poured into a rectangular glass pan (250×350 mm areal dimensions) and left resting in a fume hood for 24 to 48 hours until the DCM had evaporated.

### Example 2

### Melt-Blending SnOx-PLA

Due to the long wait time (about 24 to 48 hours) associated with DCM evaporation in the solvent-blending approach, a melt-blending technique was pursued to increase sacrificial polymer production. A twin-blade measuring mixer (Type Six, Brabender was heated to 170° C. after which 60 g of PLA (4043D, Natureworks) was added to the chamber while rotating mixing blades at 15 RPM until completely melted. The desired proportion of SnOx (per wt. % of PLA) was slowly added and then mixed at 45 RPM for 15 minutes. The melt-compounded SnOx/PLA was extracted from the chamber and cut while still pliable (with scissors), into irregular pieces with nominal dimensions less than 25×15×15 mm. Melt-compounding and pelletizing (3×3×4 mm) on the kilogram batch scale was achieved by a commercial manufacturer. A catalyst concentration of 3% (by wt. % of the PLA) was selected for the large-scale, commercial compounding/pelletizing as it provided a balance between evacuation time and residual mass in the solvent-blended studies.

### Example 3

### Comparative Thermal Degradation of PLA from Various Blending Techniques

The evacuation characteristics of solvent- and melt-blended PLA was characterized by isothermal thermogravimetric analysis (iTGA) at 200° C. for 16 hours, and compared to neat PLA and prior solvent-infused sacrificial fibers [9]. Representative iTGA traces (FIG. 2) show that neat PLA exhibited less than a 5% weight loss over the 16 hour time interval, whereas both solvent-blended and solvent-infused sacrificial fibers reached a plateau residual mass, equivalent to the original amount of catalyst incorporated, indicating that complete depolymerization and evacuation of the PLA has occurred. As SnOx catalyst concentration increased (1, 3, 5, and 10 wt %), the time to achieve PLA evacuation decreases (about 15, 12, 9, and 6 hours, respectively). Thus, a trade-off exists between PLA evacuation time and evacuation effectiveness, for which the latter becomes especially important for in situ removal when embedded in a structural polymer/composite matrix. The prior solvent-infused fibers [9] show the greatest proportion of residual catalyst, later confirmed to be surface agglomerations (FIG. 1). The melt-compounded PLA/SnOx exhibited the fastest overall evacuation time (less than 6 hours) and lowest residual mass within the 16 hour, 200° C. iTGA run. Without being bound to any particular theory, producing a uniform distribution of SnOx catalyst throughout the PLA appears to lead to evacuation consistency.

### Example 4

### Melt-Spinning of Sacrificial (SnOx/PLA) Fibers

Prior to melt-processing, blended sacrificial PLA polymer was dried in an oven at 70° C. under vacuum (13 Torr) for at least 6 hours to remove any additional solvent and/or ingressed moisture that could lead to hydrolytic degradation of PLA and a decrease in its molecular weight [16, 17, 18]. Sacrificial fibers (650-850 μm in diameter) were produced using a modified lab-scale, melt-spinning apparatus (extruder) shown in FIG. 3A. Sacrificial polymer pieces/pellets (30 g) were loaded into a steel barrel and allowed to melt for 45 minutes at 175° C. Next, a polytetrafluoroethylene (PTFE) disk followed by brass capped steel piston were inserted into the top barrel opening and mechanically advanced to extrude SnOx/PLA material through a 1.25 mm diameter spinneret at a rate of approximately 5.5 g/min. The extruded fiber was guided over a metal pulley and laterally translated to provide uniform spooling around the winding reel. Rotational speed of the 88 mm diameter take-up reel was adjusted to control fiber size, i.e. faster winding results in diameter reduction for a given extrusion rate. At a winding rate of 41 RPM (measured by a calibrated bicycle computer FIGS. 5B and 5C) a single extrusion run produced roughly 60 m of continuous 650 μm diameter fiber (Table 1). As determined by X-ray computed microtomography, fibers produced via in-house melt-spinning exhibited uniform, internal SnOx catalyst distribution (FIG. 1) compared to surface agglomeration in solvent-infused commercial monofilament.

### Example 5

### Heated Drawing of Melt-Spun Sacrificial (PLA/SnOx) Fibers

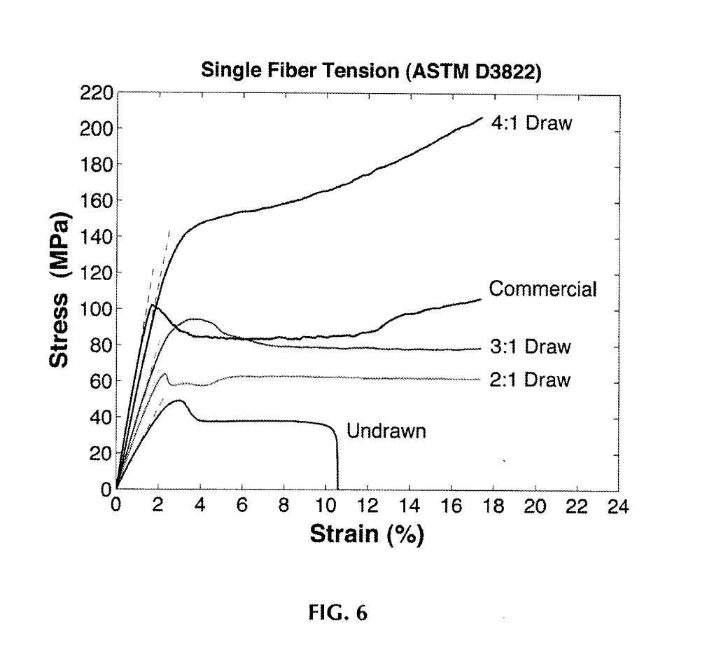

Post-spinning, heated fiber-drawing (stretching) of PLA above the glass-transition temperature (about 57° C.) [15] and below the melting temperature (about 160° C.) [14] was found to improve mechanical properties, for a given average molecular weight, due to increased orientation (crystallinity) of polymer chains [16, 17, 18]. Initial drawing studies were conducted on short segments of melt-spun fiber (about 15 cm in length) that were stretched (drawn) to a length ratio of 3:1 (final/initial) in a heated oven (80° C.) by vertically suspending a mass equivalent to one-fourth the undrawn yield stress (about 10 MPa). Mechanical properties were assessed by single-fiber tension testing to determine relevant parameters for scale-up. To produce longer, continuous lengths of drawn fibers, an automated drawing machine (based on the oven-drawn thermal/mechanical guidelines) was developed. Draw length ratios ranging between 2:1 and 5:1 were found to be achievable. Post-drawn fibers, produced by either technique, exhibited less variation in diameter with increasing draw ratio compared to melt-spun fibers taken directly off the winding reel. Representative tensile, stress-strain behavior for various fiber draw ratios is presented in FIG. 6. As the draw ratio increased, a noticeable increase in elastic modulus and yield stress also occurred. An important property for successful weaving of a sacrificial fiber (under applied tension) around a tight radius of curvature, is the enhanced post-yield ductility and strain hardening behavior evident in the commercial and in-house drawn (4:1) fibers. A summary of the average yield stress, yield strain and elastic modulus calculated up to 1% strain is provided in Table 2.

### Example 6

### Melt-Extrusion of Sacrificial (SnOx/PLA) Filaments

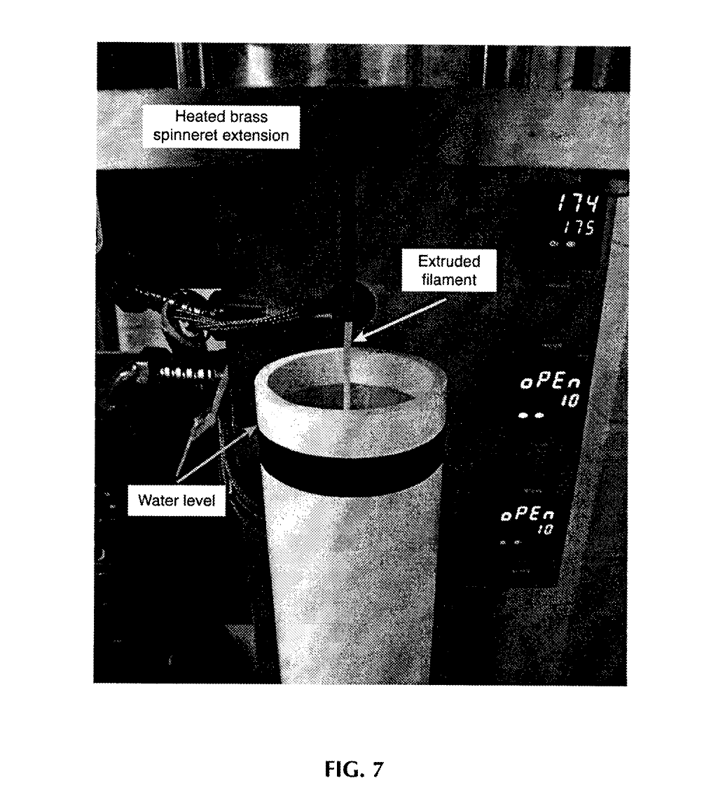

Prior to melt-processing, blended sacrificial polymer was dried in an oven at 70° C. under vacuum (13 Torr) for at least 6 hours to remove any additional solvent and/or ingressed moisture that could lead to hydrolytic degradation of PLA molecular weight [16, 17, 18]. Larger filament feedstock (about 3 mm in diameter) for fused deposition modeling (FDM) was initially produced using the same melt-spinning apparatus of Example 4 at a temperature of 175° C. by extruding sacrificial polymer through a heated brass spinneret extension (75 mm long, 2.5 mm internal diameter) into an RT water column roughly 1.2 meters in height (FIG. 7). Resulting filaments ranged from 2.4 mm to 3.1 mm in diameter, within printable tolerances for commercial FDM equipment. High volume production of two commonly used FDM filament diameters, i.e. 1.75 mm and 3.0 mm, was also carried out (results not shown).

### Example 7

### Fused Deposition Modeling (FDM) of Branched Sacrificial Templates

In this FDM example, a sacrificial filament including PLA and SnOx was passed through the extrusion nozzle of an FDM device, extruded onto a heated stage, and allowed to cool and solidify, resulting in robust network precursors that survived fiber-reinforced composites manufacturing. Branched, planar network templates (FIG. 3A) were printed using a desktop FDM (AO-100, Lulzbot). A solid model of the geometry was created via CAD (SolidWorks v.2011, Dassault Systemes) and converted to stereolithography (STL) data format. The STL file was then converted to instructional G-code using open source software (Slic3r v.0.9.10b). The G-code was manually edited to further optimize printing pathways. Printing was conducted in two thickness (z) layers with a nozzle diameter of 0.35 mm, a nozzle temperature between 180-185° C., and a bed (stage) temperature between 85-90° C. The printer stage was covered with polyethylene terephthalate (PET) tape and roughened with light sanding (320 grit) to enhance surface adhesion of the printed template. A double layer deposition, including initial calibration border took approximately 1 minute to complete. The bed temperature was lowered to 40° C. (below PLA glass-transition temperature) before removing the sacrificial templates and a final trim of any stray PLA fibrils. Nominal dimensions for straight segments of the printed templates measured 350 μm wide by 550 μm thick. Scanning electron micrographs of an evacuated network cross-section (FIG. 3B) revealed an “hourglass” through-thickness construction resulting from the dual-layer FDM technique, where each interconnected lobe was roughly equal in area (top—0.075 mm², bottom—0.084 mm²) to that of a 300 μm diameter, circular channel cross-section (0.071 mm²).

### Example 8

### Incorporation of Sacrificial Melt-Spun/Heated-Drawn Fibers and FDM Branched Templates in a Fiber-Reinforced Composite

An interconnected microvascular network was constructed by joining sacrificial melt-spun fibers with FDM (printed) branched templates. A woven, glass-fiber composite preform (8-harness satin E-glass, [90/0]4) was prepared by hand stitching melt-spun/post-drawn sacrificial PLA fibers (300 μm) in a parallel configuration, while concurrently restraining two branched network precursors (FIG. 3A) on the outer (top) ply surface (FIG. 4A). The through-thickness sacrificial fibers and planar network precursors were then chemically bonded by solvent-welding the points of contact via manual injection of a solution of PLA/SnOx (5% SnOx by weight of the PLA) dissolved in dichloromethane, producing the structure of FIG. 4B. After air-drying at room temperature for least 48 hours, 4 layers of 8-harness satin fabric were placed on both top and bottom of the stitched preform and then consolidated into a composite laminate via VARTM (FIG. 4C). The final thermal PLA evacuation (VaSC) step produced the first 3D branched, microvascular composite. By filing the empty vasculature with a liquid, radiocontrast agent (Iohexyl) followed by X-ray computed microtomography, the interconnected network of microchannels was visualized (FIG. 4D).

### Example 9

### Comparing Catalyst Reactivity

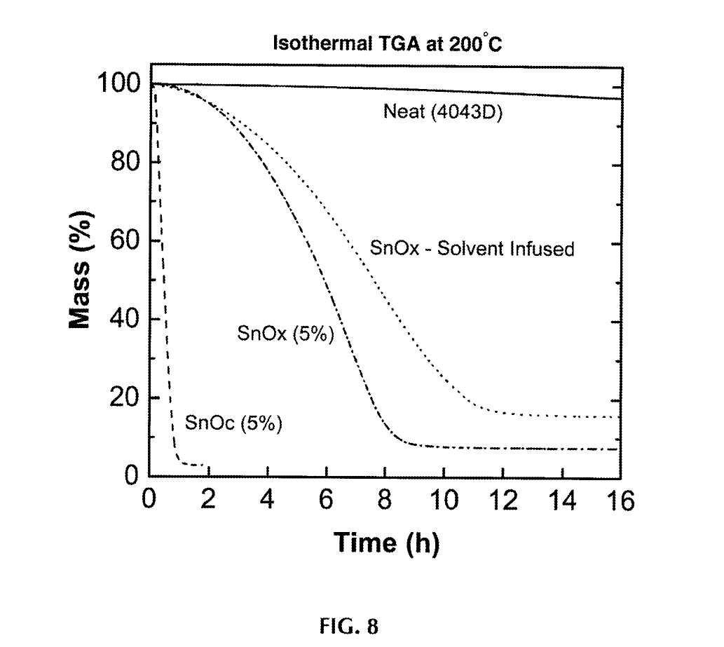

To demonstrate the effect of catalyst reactivity on vaporization of PLA, two different sacrificial polymers were produced: (1) PLA (Ingeo 4043D, Natureworks, Mw 150 kDa) with 5% tin (II) oxalate (SnOx) by weight PLA; and (2) PLA (Ingeo 4043D, Natureworks, Mw 150 kDa) with 5% tin (II) octoate (SnOc) by weight PLA. Isothermal thermogravimetric analysis (iTGA) was conducted at 200° C. under continuous nitrogen purge to characterize the degradation process (FIG. 8).

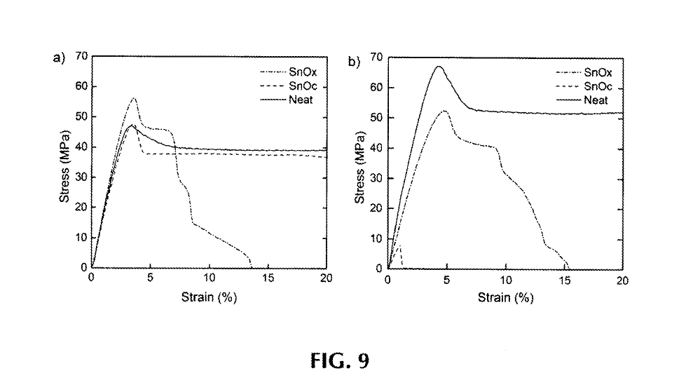

Specimens containing SnOx in the form of solid particles decomposed in about 10-12 hours, while specimens containing SnOc added as a liquid decomposed in about 1 hour (FIG. 8). Although PLA containing SnOc showed superior decomposition, it degraded so rapidly at the typical processing temperatures for melt-compounding/melt-spinning/FDM (˜175° C.), that it became impractical for these techniques (FIG. 9). In contrast, the slower depolymerization rate with SnOx made it well suited for melt-processing techniques, demonstrating the tunability of VaSC for the intended sacrificial polymer processing method.

While various embodiments of the invention have been described, it will be apparent to those of ordinary skill in the art that other embodiments and implementations are possible within the scope of the invention. Accordingly, the invention is not to be restricted except in light of the attached claims and their equivalents.

### REFERENCES

[1] E. Katifori, G. J. Szöll\acute{ó}si, and M. O. Magnasco. Damage and fluctuations induce loops in optimal transport networks. Physical Review Letters, 104:1-4, 2010.
[2] D. Therriault, S. R. White, and J. A. Lewis. Chaotic mixing in three-dimensional microvascular networks fabricated by direct-write assembly. Nature Materials, 2:265-271, 2003.
[3] D. Therriault, R. F. Shepherd, S. R. White, and J. A. Lewis. Fugitive inks for direct-write assembly of three-dimensional microvascular networks. Advanced Materials, 17:395-399, 2005.
[4] K. S. Toohey, N. R. Sottos, J. A. Lewis, J. S. Moore, and S. R. White. Self-healing materials with microvascular networks. Nature Materials, 6:581-585, 2007.
[5] K. S. Toohey, C. J. Hansen, J. A. Lewis, S. R. White, and N. R. Sottos. Delivery of two-part self-healing chemistry via microvascular networks. Advanced Functional Materials, 19:1399-1405, 2009.
[6] C. J. Hansen, W. Wu, K. S. Toohey, N. R. Sottos, S. R. White, and J. A. Lewis. Self healing materials with interpenetrating microvascular networks. Advanced Materials, 21:4143-4147, 2009.
[7] A. R. Hamilton, N. R. Sottos, and S. R. White. Self-healing of internal damage in synthetic vascular materials. Advanced Materials, 22:5159-5163, 2010.
[8] C. J. Hansen, S. R. White, N. R. Sottos, and J. A. Lewis. Accelerated self-healing via ternary interpenetrating microvascular networks. Advanced Materials, 21:4320-4326, 2011.
[9] A. P. Esser-Kahn, P. R. Thakre, H. Dong, J. F. Patrick, V. K. Vlasko-Vlasov, N. R. Sottos, J. S. Moore, and S. R. White. Three-dimensional microvascular fiber-reinforced composites. Advanced Materials, 23:3654-3658, 2011.
[10] H. Dong, A. P. Esser-Kahn, P. R. Thakre, J. F. Patrick, N. R. Sottos, S. R. White, and J. S. Moore. Chemical treatment of poly(lactic acid) fibers to enhance the rate of thermal depolymerization. Applied Materials & Interfaces, 4:503-509, 2012.
[11] J. F. Patrick, K. R. Hart, B. P. Krull, C. E. Diesendruck, J. S. Moore, S. R. White, and N. R. Sottos. Continuous self-healing life cycle in vascularized structural composites. Advanced Materials, 26:4302-4308, 2014.
[12] ASTM International. ASTM E1356: Standard Test Method for Assignment of the Glass Transition Temperatures by Differential Scanning calorimetry, 2008.
[13] ASTM International. ASTM D3822: Standard Test Method for Tensile Properties of Single Textile Fibers, 2007.
[14] NatureWorks, LLC, 15305 Minnetonka Boulevard, Minnetonka, Minn. 55345, USA. Ingeo™ Biopolymer 4043D Technical Data Sheet, December 2013.
[15] D. Cava, R. Gavara, J. M. Lagarón, and A. Voelkel. Surface characterization of poly(lactic acid) and polycaprolactone by inverse gas chromatography. Journal of Chromatography A, 1148:86-91, 2007.
[16] A. Sodergard and M. Stolt. Properties of lactic acid based polymers and their correlation with composition. Progress in Polymer Science, 27:1123-1163, 2002.
[17] J. A. Cicero, J. R. Dorgan, S. F. Dec, and D. M. Knauss. Phosphite stabilization effects on two-step melt-spun fibers of polylactide. Polymer Degradation and Stability, 78:95-105, 2002.
[18] D. E. Henton, P. Gruber, J. Lunt, and J. Randall. Polylactic acid technology. In A. K. Mohanty, M. Misra, and L. T. Drzal, editors, Natural Fibers, Biopolymers, and Biocomposites, chapter 16, pages 527-577. CRC Press Taylor & Francis Group, Boca Raton, Fla., USA, 2005.

What is claimed is:

1. A method of making a sacrificial fiber, comprising:
forming a molten sacrificial composition comprising a poly(hydroxyalkanoate) and a metal catalyst; and
extruding the molten sacrificial composition to form a sacrificial fiber comprising the poly(hydroxyalkanoate) and the metal catalyst,
where the concentration of the metal catalyst in the molten sacrificial composition is at least 0.1 wt %.

2. The method of claim 1, where the poly(hydroxyalkanoate) is poly(lactic acid).

3. The method of claim 1, where the metal catalyst is SnOx.

4. The method of claim 1, where the concentration of the metal catalyst in the molten sacrificial composition is at least 1 wt %.

5. The method of claim 1, where the concentration of the metal catalyst in the molten sacrificial composition is from 2.5 to 3.5 wt %.

6. The method of claim 1, where the weight average molecular weight of the poly(hydroxyalkanoate) is at least 50 kDa to at most 500 kDa.

7. The method of claim 1, where the forming the molten sacrificial composition comprises:
mixing ingredients comprising the poly(hydroxyalkanoate) and the metal catalyst, to form a sacrificial polymer, and
heating the sacrificial polymer to a temperature equal to or above the melting temperature of the poly(hydroxyalkanoate).

8. The method of claim 7, where the sacrificial polymer is formed by solvent-blending or by melt-blending.

9. The method of claim 7, further comprising at least one of sieving and grinding the metal catalyst.

10. The method of claim 1, further comprising heated-drawing the sacrificial fiber.

11. The method of claim 1, where the sacrificial fiber is a sacrificial filament.

12. A method of forming a polymeric degradable structure, comprising:
supplying a sacrificial filament to an extrusion nozzle,
extruding the sacrificial filament from the extrusion nozzle, and
depositing the sacrificial filament, to form the degradable polymeric structure,
the sacrificial filament comprising a poly(hydroxyalkanoate) and a metal catalyst,
where the concentration of the metal catalyst in the sacrificial filament is at least 0.1 wt %.

13. The method of claim 12, where the poly(hydroxyalkanoate) is poly(lactic acid).

14. The method of claim 12, where the metal catalyst is SnOx.

15. The method of claim 12, where the concentration of the metal catalyst in the sacrificial filament is at least 1 wt %.

16. The method of claim 1, where the concentration of the metal catalyst in the sacrificial filament is from 2.5 to 3.5 wt %.

17. The method of claim 1, further comprising at least one of: bonding a sacrificial fiber to the sacrificial polymeric structure; bonding a sacrificial polymeric structure to the sacrificial polymeric structure; and bonding a sacrificial fiber to a sacrificial fiber.

18. In a method of forming a polymeric structure, the method comprising: feeding a filament to a fusion deposition modeling device, extruding the filament, and depositing the filament to form the structure, the improvement comprising: feeding to the fusion deposition modeling device a filament comprising a poly(hydroxyalkanoate) and a metal catalyst, where the concentration of the metal catalyst in the filament is at least 0.1 wt %.

19. The method of claim 18, where the poly(hydroxyalkanoate) is poly(lactic acid).

20. The method of claim 18, where the metal catalyst is SnOx.
